(19) United States
(12) Patent Application Publication
(10) Pub. No.: US 2024/0388930 A1
(43) Pub. Date: Nov. 21, 2024

(54) INTERRUPTION FREE COMMUNICATION IN WIRELESS COMMUNICATION NETWORK

(71) Applicant: Telefonaktiebolaget LM Ericsson (publ), Stockholm (SE)

(72) Inventors: Göran BERNEFORS, Vällingby (SE); Magnus JOHANSSON, Göteborg (SE); Walter MÜLLER, Upplands Väsby (SE); Anders EDMAN, Linköping (SE); Jacob ÖSTERLING, Järfälla (SE)

(21) Appl. No.: 18/693,771

(22) PCT Filed: Sep. 24, 2021
(86) PCT No.: PCT/SE2021/050934

§ 371 Date: Mar. 20, 2024

(51) Int. Cl. H04W 24/04

(52) U.S. Cl. CPC H04W 24/04

(57) ABSTRACT

Embodiments of the present disclosure provide a method, a first node, a second node, and a computer program product for providing an interruption free communication, in a wireless communication network. The method is performed by a second node in the wireless communication network. The method includes detecting that one or more management operations are to be executed at the second node, the execution of the one or more management operations causing an interruption of the wireless communication to from a user equipment. Upon detecting that the one or more management operations are to be executed at the second node, the method includes receiving an indication from one or more first nodes, the indication indicating to the second node whether or not to execute the one or more management operations. Further, the method includes determining to execute the one or more management operations based on the received indication.

### TECHNICAL FIELD

The present disclosure relates generally to the field of wireless communication. More particularly, it relates to methods, first node, second node and computer program products for interruption free communication in a wireless communication network.

### BACKGROUND

Wireless mobile communication technology uses various standards and protocols to transmit data between a base station and a communication device. Wireless communication system standards and protocols include the 3rd Generation Partnership Project, 3GPP, the Institute of Electrical and Electronics Engineers IEEE 802.16 standard, which is commonly known to industry groups as worldwide interoperability for microwave access, WiMAX and the IEEE 802.11 standard for wireless local area networks, WLAN, which is commonly known to industry groups as Wi-Fi.

In 3GPP radio access networks, RANs, in LTE systems, a base station can include a RAN Node such as an Evolved Universal Terrestrial Radio Access Network, E-UTRAN and/or Radio Network Controller, RNC in an E-UTRAN, which communicates with the communication device, known as user equipment, UE. In fifth generation, 5G, wireless RANs, RAN Nodes can include a 5G Node e.g., En-gNB. The RAN provides access to communication services through a core network.

The RAN in recent times has evolved from a traditional RAN to an open RAN, O-RAN as shown in FIG. 1A. A core network 106 may be connected to the UE 108 through the RAN. The core network 106 may include a serving gateway, SGW, a packet data network, PDN, gateway PGW, an access network detection and selection function, ANDSF, server, an enhanced packet data gateway, ePDG, and/or a mobility management entity, MME or the like.

The legacy way of providing the RAN is that there is a single entity and the internal interfaces within that box are closed and are in hands of one vendor of the RAN. In the O-RAN, there exists a functional split between different functions of the RAN into the following entities namely a centralized unit, CU 101, a distributed unit, DU 102, and a radio unit, RU 104 with open interfaces between them. A similar architecture is defined within 3GPP, but with the O-RAN approach, those entities can be developed by different vendors due to the open interfaces between the entities, including Open Fronthaul, Open FH. Therefore, the O-RAN includes Disaggregation of the RAN into the mentioned functions i.e., the CU 101, the DU 102, and the RU 104, and opening of internal RAN interfaces as shown in the FIG. 1A.

An O-RAN Lower Layer Split, OLLS is defined between the DU 102 and the RU 104 for management plane, synchronization plane, control plane and user plane, and also between a Network Management System, NMS and the RU for complementary management. In a typical deployment, one or more DUs may use many RUs to serve multiple sectors and/or carriers as shown in FIG. 1B. The DUs may then control the RUs with respect to carrier configuration, and radio resource usage. Additionally, the NMS (not shown) can control the RUs, typically for SW management and HW fault management. The DUs may contain multiple boards, but in this deployment, the multiple boards are coordinated, for instance by a single control SW.

In another deployment alternative, multiple DUs may use the same RU, for instance in case of two operators sharing the same RU. The configuration and run time operation of the RU is uncoordinated. The RU has the responsibility to reconfigure hardware needed to run the carriers, including recurring actions such as calibration and temperature compensation. Traditionally, the RU has been allowed to generate short interruptions in the traffic during these actions, as the impact on the traffic is negligible.

In some examples, when the RU changes its configuration, either due to new parameters on the management plane or due to any local recovery action, ongoing communication may be interrupted, which may violate the requirements on the connection carried over the RU(s).

### SUMMARY

Consequently, there is a need for a method and arrangement for providing interruption free communication in a wireless communication network.

It is therefore an object of the present disclosure to provide a method, a first node, a second node, and a computer program product for interruption free communication that seeks to mitigate, alleviate, or eliminate all or at least some of the above-discussed drawbacks of presently known solutions.

This and other objects are achieved by means of a method, a computer program product, and a device as defined in the appended claims. The term exemplary is in the present context to be understood as serving as an instance, example or illustration.

According to a first aspect of the present disclosure, a method for an interruption free communication over in a wireless communication network is provided. The method is performed by a second node in the wireless communication network. The method comprises detecting that one or more management operations are to be executed at the second node the execution of the one or more management operations causing an interruption of the wireless communication to from a user equipment. Upon detecting that the one or more management operations are to be executed at the second node, the method comprises receiving an indication from one or more first nodes, said indication indicating to the second node whether or not to execute the one or more management operations. Further, the method comprises determining to execute the one or more management operations based on the received indication.

In some examples, the first node may be a distributed unit, DU, which may also be a first user plane node or a first control plane node. Further, the second node may be a radio unit, RU, which may also be a second user plane node or a second control plane node. The first node and the second node are the functions within a radio access network, RAN, or a network node.

In some embodiments, the method further comprising indicating to the one or more first nodes that the one or more management operations are to be executed at the second node.

In some embodiments, the step of indicating to the one or more first nodes that the one or more management are to be executed at the second node comprises transmitting a request message to the one or more first nodes. The request message indicating to the one or more or first nodes to allow the execution of the one or more management operations.

In some embodiments, the method further comprising awaiting for a pre-configured time interval after transmitting the request message, for receiving the indication from one or more first nodes on whether or not to execute the one or more management operations.

In some embodiments, the step of determining to execute the one or more management operations based on the received indication comprises determining if the received indication indicates to execute the one or more management operations and executing the one or more management operations.

In some embodiments, the method further comprising awaiting for a pre-configured time interval without transmitting the request message to the one or more first nodes and not expecting the indication from one or more first nodes on whether or not to execute the one or more management operations.

In some embodiments, the method further comprising determining the expiry of the pre-configured time interval for receiving the indication which indicates to execute the one or more management operations and performing one more of: executing the one or more management operations, delaying the execution of the one or more management operations for a pre-determined time interval and rejecting the one or more management operations.

In some embodiments, the method further comprising determining if the received indication indicates not to execute the one or more management operations and performing one of: executing the one or more management operations, delaying the execution of the one or more management operations for a pre-determined time interval and rejecting the one or more management operations.

In some embodiments, the method further comprising determining if the received indication indicates the second node may execute the one or more management operations and executing the one or more management operations in a sequential order defining the one or more management operations.

In some embodiments, the method further comprising determining if the execution of the one or more management operations are delayed for a pre-determined time interval. The method comprises determining if the received indication indicates that the second node may execute the one or more management operations and executing the one or more management operations in a sequential order defining the one or more management operations.

In some embodiments, the one or more management operations causing the interruption of the wireless communication comprises internal management operations or external management operations at the second node.

In some embodiments, wherein the one or more internal management operations or the external management operations comprise one or more of: software management, configuration management, performance measurement, fault management, retuning and recovery, power management, antenna calibration and activation of a load generator.

According to a second aspect of the present disclosure, a method for an interruption free communication, in a wireless communication network is provided. The method is performed by a first node in the wireless communication network. The method comprises determining that priority-based data being communicated over one or more second nodes to and from a user equipment, UE, in the wireless communication network is to be continued without any interruption, for execution of one or more management operations at one or more second nodes. Upon determining that the priority-based data being communicated over one or more second nodes to and from the UE is to be continued without any interruption, the method comprises transmitting an indication to the one or more second nodes. The indication indicating to the one or more second nodes whether or not to execute any management operations.

In some embodiments, the method further comprising receiving an indication from the one or more second nodes that the one or more management operations are to be executed at the one or more second nodes.

In some embodiments, the step of receiving the indication from the one or more second nodes that the one or more management operations are to be executed at the second node comprises receiving a request message from the one or more second nodes. The request message indicating to the first node that one or more management operations are to be executed at the one or more second nodes which one or more management operations interrupt the priority-based data communication.

In some embodiments, the request message further comprises an indication for the one or more first nodes (102a-102n) to allow the interruption of the priority-based data being communicated over the second node.

In some embodiments, the method further comprising continuously evaluating whether a priority-based data being communicated over one or more second nodes to and from the UE is to be continued without any interruption and transmitting an indication to the one or more second nodes. The indication indicating to the one or more second nodes whether to execute the one or more management operations.

In some embodiments, the method further comprising determining that the one or more management operations are being executed at the one or more second nodes and avoiding setting up of other priority-based data over the one or more second nodes communication until the one or more management operations are executed at the one or more second nodes.

In some embodiments, the one or more management operations causing the interruption of the wireless communication comprises internal management operations or external management operations at the one or more second nodes.

In some embodiments, the internal management operations or external management operations comprise one or more of: software management, configuration management, performance measurement, fault management, retuning and recovery, power management, antenna calibration and activation of a load generator.

According to a third aspect of the present disclosure, a second node in a wireless communication network for an interruption free communication is provided. The second node being adapted for detecting that one or more management operations are to be executed at the second node. The execution of the one or more management operations causing an interruption of the wireless communication to from a user equipment. When it is detected that the detecting that the one or more management operations are to be executed at the second node, the second node being adapted for receiving an indication from one or more first nodes, the indication indicating to the second node whether or not to execute the one or more management operations. Further, the second node being adapted for determining to execute the one or more management operations based on the received indication.

According to a fourth aspect of the present disclosure, a first node in a wireless communication network for an interruption free communication is provided. The first node being adapted for determining that a priority-based data being communicated over one or more second nodes to and from a user equipment, UE, is to be continued without any interruption, for execution of one or more management operations at one or more second nodes. When it is determined that the priority-based data being communicated over one or more second nodes to and from the UE is to be continued without any interruption, the first node being adapted for transmitting an indication to the one or more second nodes. The indication indicating to the one or more second nodes whether or not to execute the one or more management operations.

According to a fifth aspect of the present disclosure, there is provided a computer program product comprising a non-transitory computer readable medium, having thereon a computer program comprising program instructions. The computer program is loadable into a data processing unit and configured to cause execution of the method according to any of the first and second aspects when the computer program is run by the data processing unit.

An advantage of some embodiments is that alternative and/or improved approaches are provided for interruption free and prioritized communication over one or more radio units, RUs.

An advantage of some embodiments is to efficiently handle latency bound traffic over a shared RU.

An advantage of some embodiments is to perform an internal or an external management operation in the RU without causing interruption for a latency bound or sensitive traffic.

An advantage of some embodiments is to allow multiple network management systems, NMSs without high level coordination.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIGS. 1A and 1B disclose an example wireless communication network;

FIG. 2 is a flowchart illustrating example method steps of a method performed by a second node in the wireless communication network for interruption free communication, according to some embodiments;

FIG. 3 is a flowchart illustrating example method steps of a method performed by a first node in the wireless communication network for interruption free communication, according to some embodiments;

FIGS. 4 and 5 disclose example modes of the second node for interruption free communication according to some embodiments;

FIG. 6 is an example sequence diagram, according to some embodiments;

FIG. 7 is an example sequence diagram, according to some embodiments;

FIG. 8 is an example sequence diagram, according to some embodiments;

FIG. 9 is an example sequence diagram, according to some embodiments;

FIG. 10 is an example sequence diagram, according to some embodiments;

FIG. 11 is an example sequence diagram, according to some embodiments;

FIG. 12 is an example schematic diagram showing functional modules of the first node according to some embodiments;

FIG. 13 is an example schematic diagram showing functional modules of the second node according to some embodiments; and

FIG. 14 discloses an example computing environment according to some embodiments.

### DETAILED DESCRIPTION

Aspects of the present disclosure will be described more fully hereinafter with reference to the accompanying drawings. The apparatus and method disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the invention. It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

It will be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

In the present disclosure, user equipments, UEs, also known as mobile terminals, and/or wireless terminals are enabled to communicate wirelessly with a radio access network or a network node in a wireless communication network.

Typically, a radio access network or a network node may serve or cover one or several cells of the wireless communication network. That is, the network node provides radio coverage in the cell(s) and communicates over an air interface with the UE(s) operating on radio frequencies within its range. The network node may be also referred to as “eNB”, “eNodeB”, “NodeB” or “gNB”, depending on the technology and terminology used. In the present disclosure, the network node device may also be referred to as a base station, BS.

It should also be noted that the network node for example, the base station is disaggregated into a centralized unit, CU, a distributed unit, DU and a radio unit, RU. Throughout the disclosure, the DU may be referred to as a first node which may also be known a first user plane node or a first control plane node. Further, the RU may be referred to as a second node which may also be known a second user plane node or a second control plane node. The first node and the second node are the functions within the RAN or the network node.

In the present disclosure, it is assumed that connection establishment has already been completed between the UE(s) and the network node.

In the following description of exemplary embodiments, the same reference numerals denote the same or similar components.

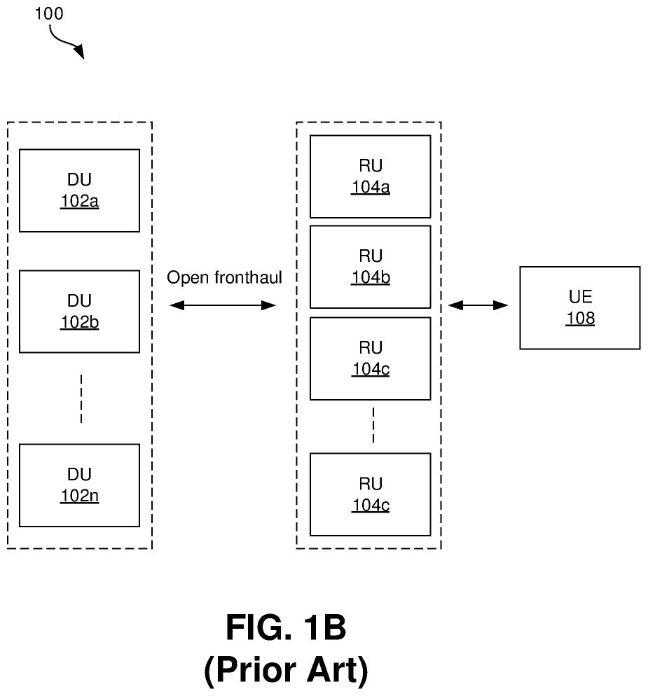

FIG. 2 is a flowchart illustrating example method steps of a method 200 performed by a second node in the wireless communication network for interruption free communication according to some embodiments. The second node performs the method 200 for interruption free communication. For example, the second node may be a second user plane node or a second control plane node which represents a radio unit, RU, in the network node.

At step 202, the method 200 comprises detecting that one or more management operations are to be executed at the second node. For example, the one or more management operations may include internal management operations or external management operations that may occur at the RU when the RU is involved in a data communication to and from a user equipment.

The internal management operations or the external management operations comprise software management, configuration management, performance measurement, fault management, retuning and recovery, power management, antenna calibration and activation of a load generator or the like.

The internal management operations or the external management operations at the RU may cause interruption of the data communication to and from the user equipment.

For example, the software management at the one or more RUs may include managing software of the RU via the DU or the network management system, NMS, with a management plane, M-Plane. In multivendor RAN environment, a NETCONF client of a certain vendor may manage software files of the RU which is heavily dependent on another vendor's implementation, and therefore a mechanism of software management that is independent of RU implementation or vendor is important.

The software management procedure may include one or more of: software inventory, software download, software installation or upgrade and software activation or the like.

In some examples, configuration management may include setting up RU parameters required on control plane, user plane and also obtaining status information of the RU via the M-Plane. The configuration management may be achieved using standard messages. The setting of required parameters is specified in the form of, for example, YANG modules and may be achieved by establishing a session which is accompanied by an exchange of <hello> messages. Sending these messages to the one or more RUs makes it possible to set various types of parameters and to obtain information on the parameters stored on the RU and the status of that RU.

In some examples, fault management at the one or more RUs may include managing the faults of the one or more RUs via the M-Plane. In this function, the RU sends a notification to the DU or NMS using a notification specified as a standard message. In the event of some sort of problem on the RU side such as an equipment fault, the RU notifies the DU of the fault together with information including fault ID, location of fault occurrence, severity of fault, new fault occurrence or a fault that has already been resolved. In some examples, over heat situation and temperature compensation, are considered to be fault management occurrences at the RU.

In some examples, retuning and recovery, antenna calibration and activation of load generator of the one or more RUs may be managed internally by the one or more RUs or externally by the one or more DUs.

In some embodiments, when it is detected that the one or more management operations needs to executed at the RU, the RU may indicate to the one or more DUs that the management operations are to be executed as illustrated by the optional step 203. In some examples, the RU may transmit a request message to the one or more DUs to indicate that the management operations are to be executed. The request message may include an indication to the one or more DUs to allow the execution of the management operations.

In some cases, the step 203 is not needed in embodiments where the one or more DUs inform the RU up-to-date with directives on how to behave when a management operation is pending. The indication from the one or more DUs indicating whether or not to execute the one or more management operations is not needed when RU executes the management operation after a certain time without waiting for the indication from the one or more DUs.

At step 204, the method 200 comprises receiving an indication from one or more first nodes. The RU receives the indication from the one or more DUs indicating whether or not to execute one or more management operations. In some examples, the RU may receive an indication to continue the data communication without causing any interruption for execution of the one or more management operations.

Thus, the RU receives the indication from the one or more DUs on whether or not to execute the management operations.

The RU awaits for a pre-configured time interval after transmitting the request message for receiving the indication from one or more DUs on whether or not to execute the one or more management operations as illustrated by the optional step 205.

At step 206, the method comprises determining to execute the one or more management operations based on the received indication from the one or more first nodes. The RU evaluates the received indication at step 208.

At step 210, the RU executes the management operations if the received indication indicates the RU to execute the management operations.

If the received indication indicates not to execute the management operations, then the RU may not execute the management operations.

In some examples, the RU may wait a for pre-configured time interval to receive the indication for execution of the management operations. In such case, if the pre-configured time interval expires and there is indication received from the one or more DUs, then at step 212, the RU may perform execution of the management operations or the RU may halt the execution of the management operations or the RU may reject the execution of the management operations.

In some examples, if the received indication indicates not to execute the management operations, then the RU may execute the management operations or the RU may delay the execution of the management operations for a pre-determined time interval. In some instances, the RU may reject the management operations.

In some examples, if the received indication indicates that the RU may execute the management operations, then the RU executes the management operations.

In some examples, the RU may delay the execution of management operations for a pre-determined time interval. In such case, if the RU receives an indication from the one or more DUs that the RU may execute the management operations, then the RU executes the management operations in a sequential order, namely, management operation 1, management operation 2, management operation 3 and so on.

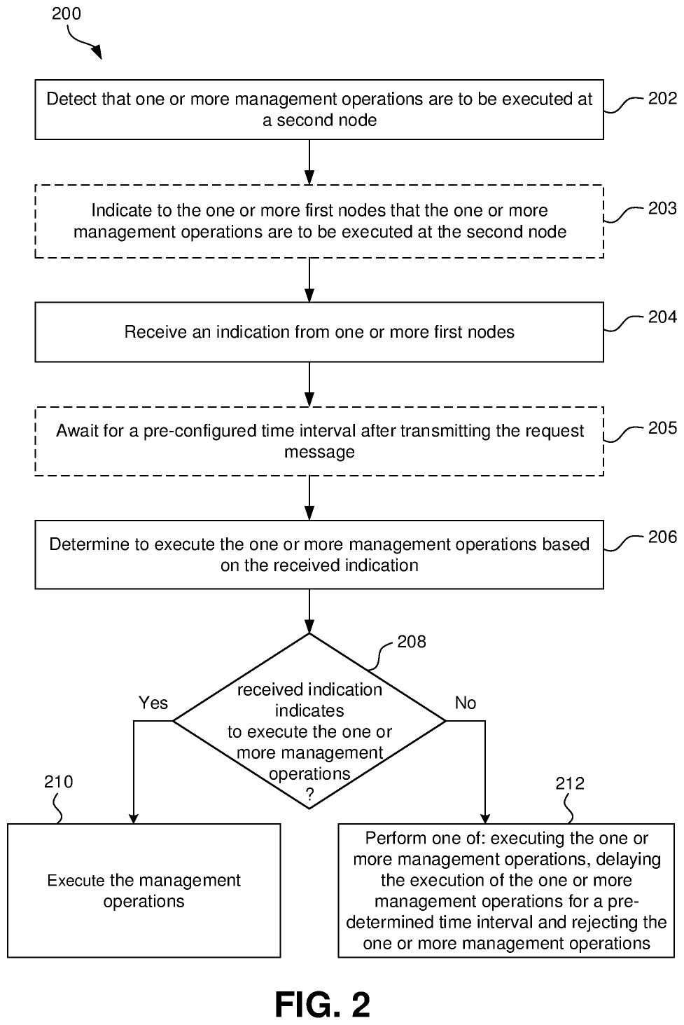

FIG. 3 is a flowchart illustrating example method 300 performed by a first node in the wireless communication network for interruption free communication. The first node performs the method 300 for interruption free communication. For example, the first node may be a first user plane node or a first control plane node which represents a distributed unit, DU, in the network node i.e., RAN. In some examples, the DU may be a logical node that comprises network node functionality, depending on the functional split between a centralized unit, CU and the DU.

The communication from the DU to the UE is referred to as downlink, DL, communication, whereas communication from the UE to the DU is referred to as uplink, UL, communication. Thus, the UE 102 involves in bidirectional radio communication with the DU over a second node i.e., a radio unit, RU.

At step 302, the method 300 comprises determining that priority-based data being communicated over one or more RUs. For example, the priority-based data may include delay sensitive data or time critical data which needs to be communicated to and from the UE over the RU without any interruption at the RU. In some examples, the DU may determine that priority-based data being communicated over one or more RUs to and from the UE based on a type of application running at the UE, where the application needs to maintain interruption-free service for certain periods of time, and the one or more RUs are not allowed to cause any spontaneous outages.

In some examples, cause for the interruption may include occurrence of events related to internal management operations or external management operations at the one or more RUs. The internal management operations or the external management operations may occur at the one or more RUs when the priority-based data is being communicated over the one or more RUs.

In some examples, the internal management operations or the external management operations comprise software management, configuration management, performance measurement, fault management, retuning and recovery, power management, antenna calibration and activation of a load generator.

Thus, the occurrence of the events related any of the internal management operations or the external management operations as described above may cause the interruption of the priority-based data being communicated over the one or more RUs to and from the UE.

In some embodiments, the DU may receive an indication from the one or more RUs that the management operations are to be executed at the one or more RUs as illustrated by the optional step 303.

When the DU determines that the priority-based data being communicated over one or more RUs to and from the UE, at step 304, the method 300 comprises transmitting an indication to the one or more second nodes i.e., RUs, the indication indicating to the one or more second nodes whether or not to execute the one or more management operations.

For example, the DU may transmit a signalling message for transmitting the indication to the one or more RUs. The indication transmitted from the DU may indicate to the one or more RUs to continue the priority-based data communication without causing any interruption during the occurrence of the events related any of the internal management operations or the external management operations.

At step 306, the method 300 comprises continuously evaluating whether priority-based data being communicated over the one or more RUs is to be continued without any interruption. If the DU determines that priority-based data being communicated over the one or more RUs is to be continued without any interruption, then at step 308, the method comprises transmitting an indication to the one or more second nodes. The indication indicates to the RUs on whether or not to execute the management operations.

At step 310, the method 300 comprises determining that the management operations are being executed at the one or more RUs. When the DU determines that the management operations are being executed at the one or more RUs, at step 312, the method 300 comprises avoiding setting up of another priority-based data communication over the one or more RUs until the one or more management operations are executed at the one or more second nodes. The DU avoids setting up of another priority-based data communication over the one or more RUs until the completion of the management operations.

In some examples, the DU may receive the request message from the one or more RUs. For example, the request message may indicate the DU that one or more internal or external management operations are pending at the one or more RUs. The request message may be a specified signalling message from the one or more RUs for indicating the DU about the internal or external management operations that are pending at the one or more RUs.

When the DU receives the request message, the DU may determine whether to move the priority-based data communication to one or more additional RUs. The DU may determine whether the one or more additional RUs are available to move the priority-based data communication. If the DU determines that one or more additional RUs are available, then the DU may allow the priority-based data communication over the one or more additional RUs. The DU may move the priority-based data communication to the one or more additional RUs in order to avoid interruption of the priority-based data communication.

In case the DU determines that the one or more additional RUs are unavailable to move the priority-based data communication or the DU determines that the priority-based data communication cannot be moved to the one or more additional RUs, then the DU may deny the request message from the one or more RUs. The DU may deny the request message from the one or more RUs and the DU may not allow the one or more internal or external management operations that are pending at the one or more RUs and thereby the DU allows the interruption free communication of the priority-based data over the one or more RUs.

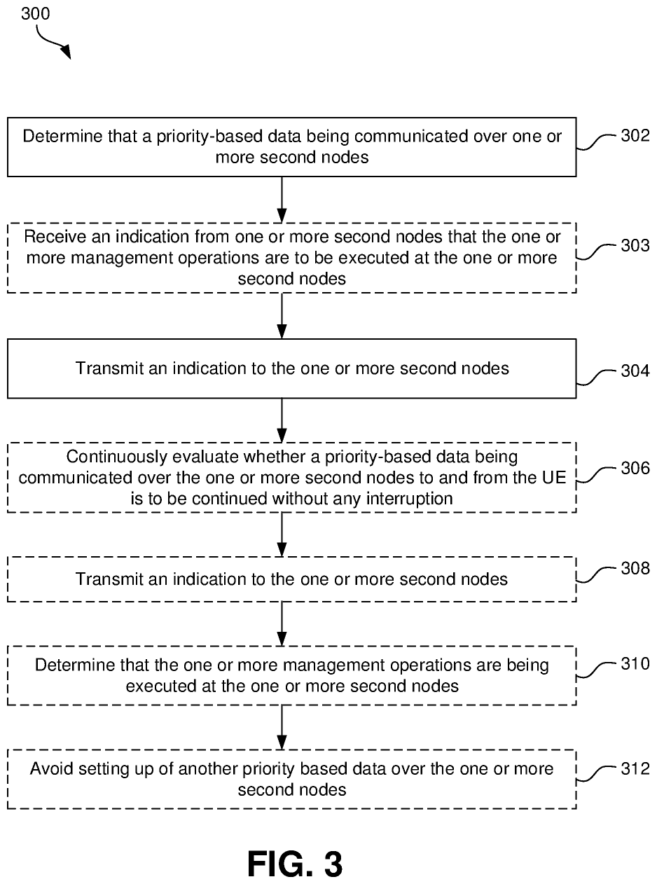

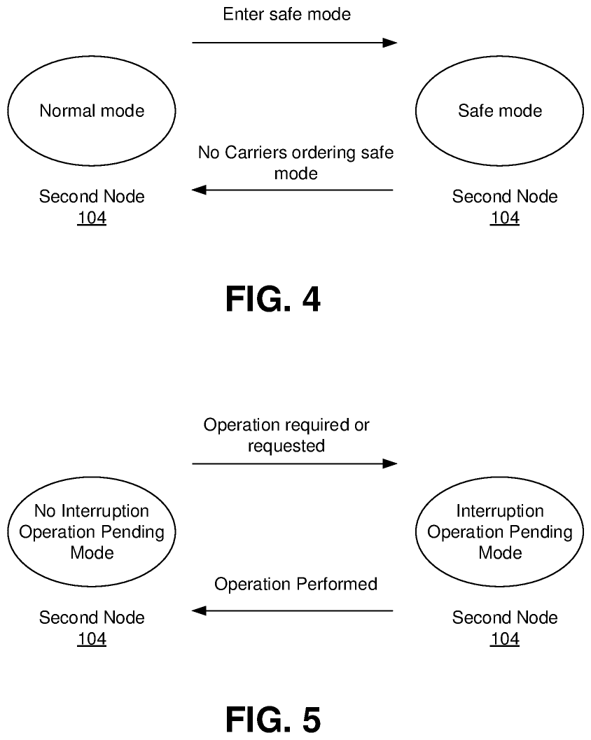

FIGS. 4 and 5 disclose example modes of the second node for interruption free communication according to some embodiments. As depicted in the FIG. 4, the second node which may be a radio unit, RU 104 may be in a normal mode and a safe mode. In normal mode, the RU 104 continues to communicate data over the RU to and from the UE. The RU 104 may continue operating in the normal mode until the RU receives an indication from the one or more DUs. The RU 104 may receive an indication from the one or more DUs, when the one or more DUs determine that the priority-based data being communicated over the RU 104 to and from the UE. When the RU 104 receives an indication that the priority-based data being communicated over the RU 104, the RU 104 may enter a safe mode in which the RU 104 may continue the priority-based data communication without causing any interruption. Thus, in the safe mode, the RU 104 may continue to communicate the priority-based data over the RU 104 to and from the UE. Further, the RU 104 may continue to be in a safe mode of operation until completion of the priority-based data communication to and from the UE. In some examples, the RU 104 may continue be in the safe mode of operation until no other DU indicates the RU 104 to be in the safe mode. When no DU is indicating the RU 104 to continue the safe mode of operation for the priority-based data communication without causing any interruption, the RU 104 may return to the normal mode. When the RU 104 returns to the normal mode, the RU 104 may communicate the data to and from the UE. The RU 104 may continue operating in the normal mode until the RU 104 receives an indication from the one or more DUs to enter the safe mode to continue the priority-based data communication without causing any interruption.

In some examples, the RU 104 may be in no interruption operation pending mode or an interruption operation pending mode as shown in FIG. 5. In no interruption operation pending mode, the RU 104 continues to communicate data to and from the UE. The RU 104 may continue operating in the no interruption operation pending mode until the RU receives the request message with an indication from the one or more DUs. When the RU 104 receives the request message with the indication, the RU 104 may enter an interruption operation pending mode in which the RU 104 may perform the internal or the external management operations including the software management, the configuration management, the performance measurement, the fault management, the retuning and recovery, the power management, the antenna calibration and the activation of a load generator or the like.

During the interruption operation pending mode, the RU 104 may allow the interruption of the priority-based data being communicated over the RU to and from the UE to perform the internal or the external management operations.

In some examples, during the interruption operation pending mode, the RU 104 may send an interrupt pending request or an interrupt allow request to the one or more DUs.

In some examples, during the interruption operation pending mode, the RU 104 may await a configured time interval to receive an interrupt allow acknowledgement message from the one or more DUs or to enter the normal mode when the interrupt allow acknowledgement message is not received after the configured time interval.

It should be noted that RU 104 may stay in interruption operation pending state until it is allowed to perform the operation (i.e., not in safe mode). The RU 104 is allowed to perform the internal or external management operation by transmitting the response message, or the internal or external management operation is no longer relevant i.e., for example some sequence have timed out anyway, or temperature has changed again)

In some examples, When the RU is in the safe mode and continuing the priority-based data communication, the RU may transmit a request message to the DU indicating that one or more internal management operations or external management operations are pending at the RU and that the one or more internal management operations or external management operations interrupt the priority-based data communication. The request message transmitted to the DU may be an interrupt pending request message or an interrupt allow request message.

After transmitting the request message to the DU, the RU may enter the interrupt operation pending mode from the safe mode. Further, the RU may continue to be in the interrupt operation pending mode for a pre-determined time interval to receive an interrupt allow acknowledgement message from the DU. If the RU receives an interrupt allow acknowledgement message from the DU, then the RU performs the one or more internal or external management operations by staying in the interrupt operation pending mode. After completion of the one or more internal or external management operations, the RU may enter no interrupt operation pending mode.

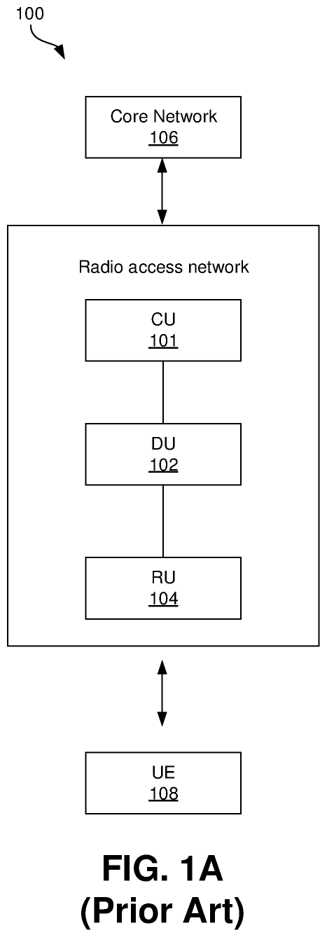

Further, in some examples, the RU 104 continues to communicate data over the RU to and from the UE in the normal mode as shown in FIG. 4. The RU 104 may continue operating in the normal mode until the RU receives an indication from the one or more DUs. The RU 104 may receive an indication from the one or more DUs as shown in FIG. 1B, when the one or more Dus determine to move the priority-based data communication to one or more additional RUs. In some examples, the RU may transmit a request message to the one or more DUs indicating that one or more internal management operations or external management operations are pending at the RU 104. In such cases, the RU may enter interruption operation pending mode as shown in FIG. 5 from the normal mode. Further, the RU performs the one or more internal or external management operations by staying in the interrupt operation pending mode. After completion of the one or more internal or external management operations, the RU may enter no interrupt operation pending mode.

In some deployments, one or more DUs may use many RUs to serve multiple sectors and/or carriers as shown in FIG. 1B. When more than one DU is connected to the same RU, the RU 104 shall indicate all DUs about operating in the safe mode or the normal mode. When the RU is in the safe mode, all DUs allow the RU 104 to continue the priority-based data communication, thereby avoiding interruption.

In some examples, the one or more DUs may receive information from the RU about whether the RU is in safe mode or not. The RU may transmit a response message indicating to the first node that the RU is in safe mode or not. In some instances, when one of the DU determines that the RU should be made interruption free, the other DUs may also be indicated that the RU should be made interruption free.

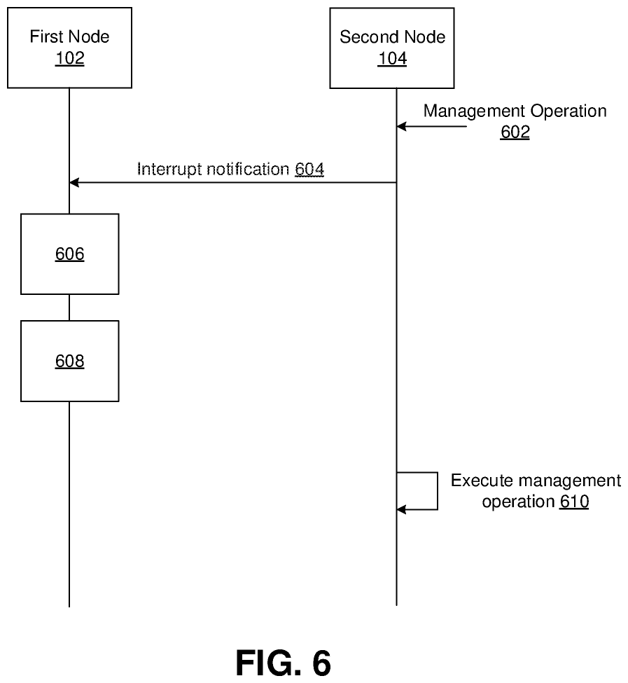

FIG. 6 is an example sequence diagram, according to some embodiments. As depicted in the FIG. 6, the second node 104, i.e., RU, detects 602 that the management operations are to be executed. When the RU detects that the management operations are to be executed, the RU transmits 604 an interrupt notification to the first node 104 i.e., DU. For example, the interrupt notification indicates to the DU that the interrupt will occur after certain time interval, for example, x milli-seconds, ms.

The DU receives the interrupt notification and evaluates 606 if any data over the RU needs to be protected. The data over the RU needs to be protected indicates evaluating whether the data over the RU is to be moved to other RUs, if possible and avoiding setting up of another priority-based data over the RU. The DU may optionally protect 608 the data over the second node for the time interval of x ms. Further, the RU executes 610 the management operations.

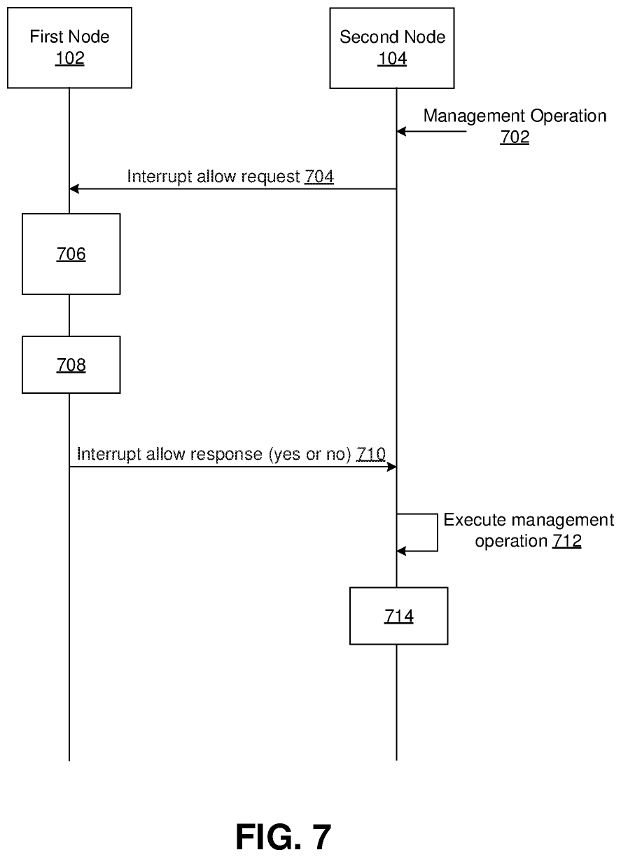

FIG. 7 is an example sequence diagram, according to some embodiments. As depicted in the FIG. 7, the second node 104, detects 702 that the management operations are to be executed. When the RU detects that the management operations are to be executed, the RU transmits 704 an interrupt allow request to the first node 104 i.e., DU.

The DU receives the interrupt allow request from the RU and evaluates 706 if any data over the RU needs to be protected. The DU may optionally protect 708 the data over the second node. Further, the DU transmits 710 an interrupt allow response message with an indication i.e., either yes or no to the RU. The RU receives the interrupt allow response message with the indication. The RU determines the received indication in the interrupt allow response message. If the received indication is ‘yes’ i.e., to allow the interruption for execution of the management operations, then the RU 712 executes the management operations. In some examples, the RU executes the management operations when all the DUs transmit the interrupt allow response message with the indication as ‘yes’ when multiple DUs control the RU 712.

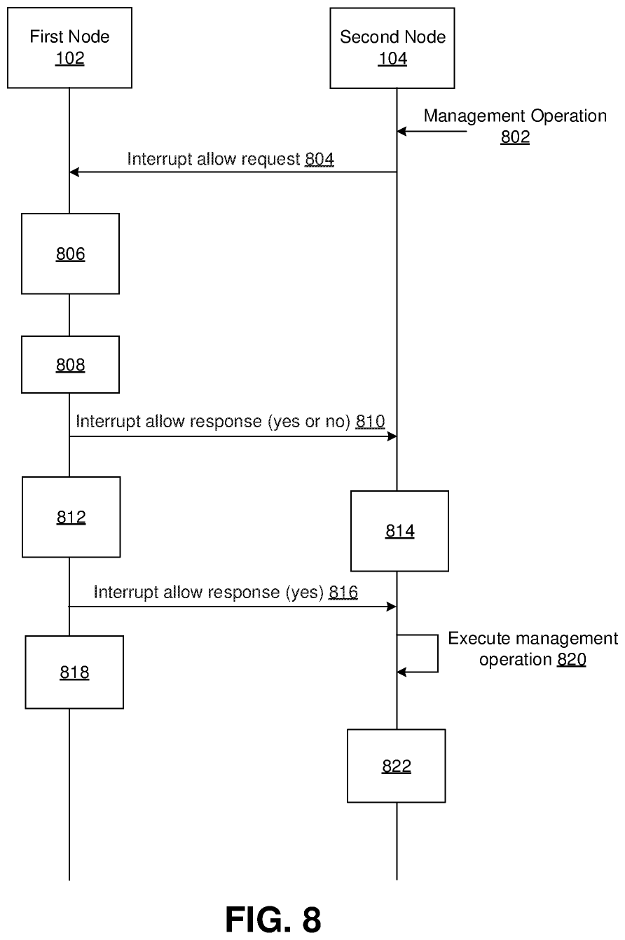

FIG. 8 is an example sequence diagram, according to some embodiments. As depicted in the FIG. 8, the second node 104, detects 802 that the management operations are to be executed. When the RU detects that the management operations are to be executed, the RU transmits 804 an interrupt allow request to the first node 104 i.e., DU.

The DU receives the interrupt allow request from the RU and evaluates 806 if any data over the RU needs to be protected. The DU may optionally protect 808 the data over the second node. Further, the DU transmits 810 an interrupt allow response message with an indication i.e., either yes or no to the RU. The RU receives the interrupt allow response message with the indication. The RU determines the received indication in the interrupt allow response message. If the received indication is ‘yes’ i.e., to allow the interruption for execution of the management operations, then the RU 814 executes the management operations.

If the DU determines not to allow the interruption for execution of the management operations, then the DU continuously evaluates 812 if any data over the RU needs to be protected. Further, when there is no needs to be protected, the DU transmits 816 an interrupt allow response message with an indication as ‘yes’ for allowing execution of the management operations at the RU and the DU stops 818 evaluating if the data over the RU is to be protected. The RU upon receiving the interrupt allow response message with an indication as ‘yes’, from all the DUs, the RU executes 820 the management operations.

In case, if the RU is awaiting the interrupt allow response message for execution of the management operations and upon expiry of a pre-determined time interval awaiting the interrupt allow response message, the RU may execute 822 the management operations or the RU may hold the execution of the management operations for certain time interval or the RU may reject the management operations.

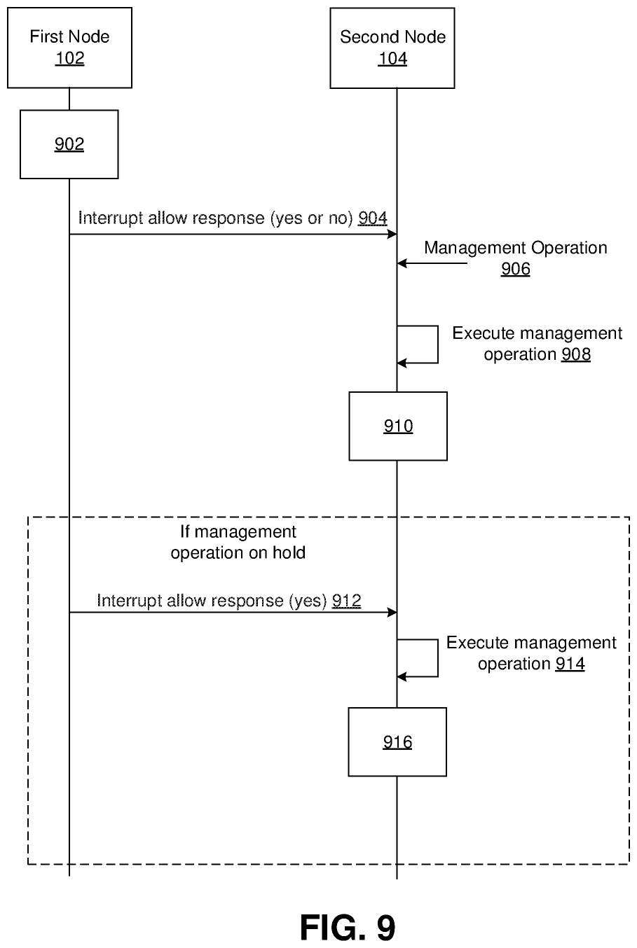

FIG. 9 is an example sequence diagram, according to some embodiments. As depicted in the FIG. 9, the DU continuously evaluates 902 if the data communication over the RU needs to be protected. The DU transmits 904 an interrupt allow response message with an indication indicating either ‘yes’ or ‘no’ for execution of the management operations. When the management operations are to be executed 906 at the RU and if the indication in the interrupt allow response is ‘yes’, then the RU executes 908 the management operations. if the indication in the interrupt allow response is ‘no’, then the RU may hold the execution of the management operations for certain time interval or the RU may reject the management operations.

In case, if the RU holds the execution of the management operations and in case the RU receives 912 an interrupt allow response message with an indication as ‘yes’, then the RU executes 914 the management operations.

In case, if the RU is awaiting the interrupt allow response message with an indication as ‘yes’ and upon expiry of a pre-configured time interval awaiting the interrupt allow response message, then the RU may execute 916 the management operations or the RU may reject the management operations.

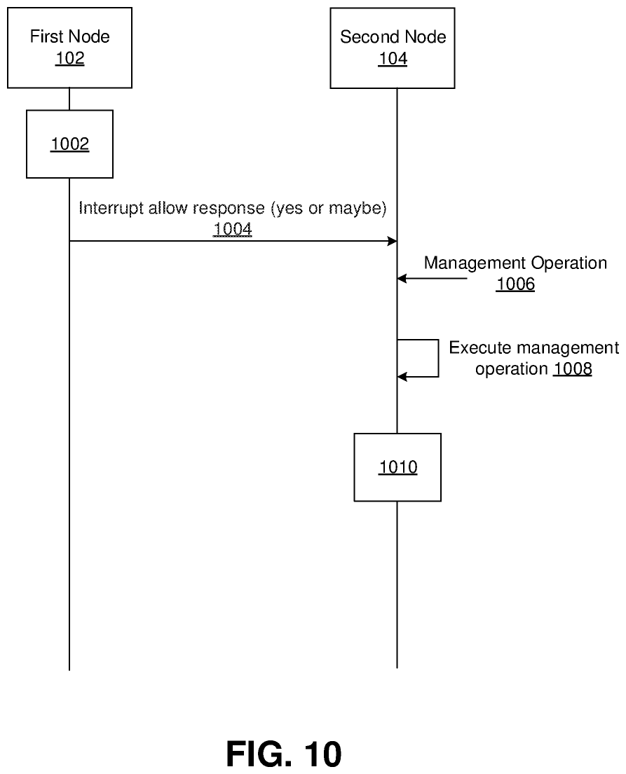

FIG. 10 is an example sequence diagram, according to some embodiments. As depicted in the FIG. 10, the DU continuously evaluates 1002 if the data communication over the RU needs to be protected. The DU transmits 1004 an interrupt allow response message with an indication indicating either ‘yes’ or ‘maybe’ for execution of the management operations. When the management operations are to be executed 1006 at the RU and if the indication in the interrupt allow response is ‘yes’, then the RU executes 1008 the management operations.

In case, if an interrupt allow response message with the indication as ‘may be’, then the RU transmits an indication to the DU for execution of the management operations. The DU after receiving the indication, protects the data communication over due to the interruption for the management operations and the DU moves the data communication over the RU to other RUs.

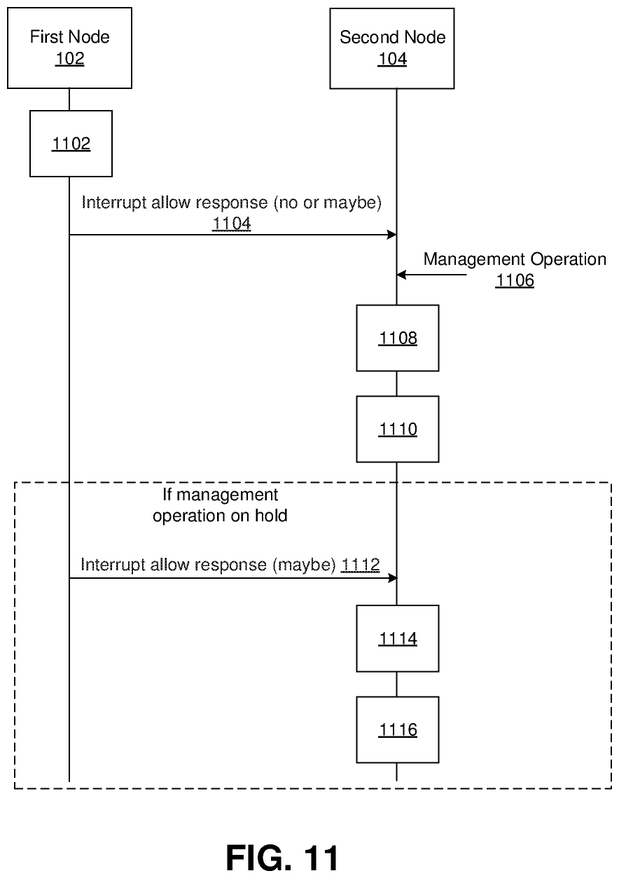

FIG. 11 is an example sequence diagram, according to some embodiments. As depicted in the FIG. 11, the DU continuously evaluates 1102 if the data communication over the RU needs to be protected. The DU transmits 1104 an interrupt allow response message with an indication indicating either ‘no’ or ‘maybe’ for execution of the management operations. When the management operations are to be executed 1106 at the RU and if the indication in the interrupt allow response is ‘maybe’, then the RU transmits an indication to the DU for execution of the management operations. The DU after receiving the indication, protects the data communication over due to the interruption for the management operations and the DU moves the data communication over the RU to other RUs

In case, if an interrupt allow response message with the indication as ‘no’, then the RU may hold the execution of the management operations for certain time interval or the RU may reject the management operations.

In case, if the RU holds the execution of the management operations and in case the RU receives 1112 an interrupt allow response message with an indication as ‘maybe’, then the RU transmits an indication to the DU for execution of the management operations. The DU after receiving the indication, protects the data communication over due to the interruption for the management operations and the DU moves the data communication over the RU to other RUs.

In case, if the RU is awaiting the interrupt allow response message with an indication as ‘maybe’ and upon expiry of a pre-configured time interval awaiting the interrupt allow response message, then the RU may execute 1116 the management operations or the RU may reject the management operations. Further, the RU may transmit an indication to the DU indicating that that the management operations are not executed.

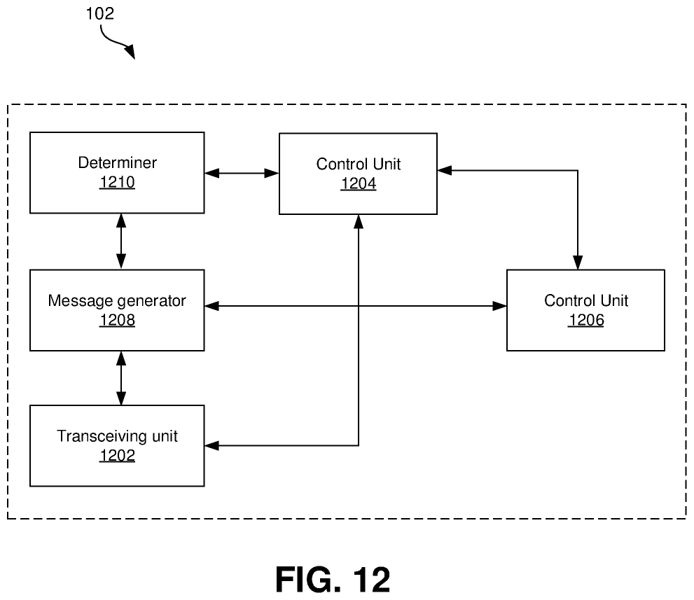

FIG. 12 is an example schematic diagram showing functional modules of the first node 102 according to some embodiments. The first node 102 may be the DU of the RAN or the DU network node. The first node node is capable of transmitting the indication to the one or more second nodes, i.e., RUs, may comprise means arranged to perform the method 300 for interruption free communication.

According to at least some embodiments of the present invention, the first node 102 in FIG. 12 comprises a transceiving unit 1202, a processor 1206 a message generator 1208 and a determiner 1210. In addition, the first node 102 may also comprise a control unit 1204, adapted to control said units.

It can be mentioned that the determiner 1210 may be merged into the processor 1206, which may be called a data processing unit, potentially also covering the control unit 1204.

The determiner 1210, and the transceiving unit 1202 as well as the control unit 1204, may be operatively connected to each other.

The function of the determiner 1210, when encompassed by the processing unit, may be performed by determining means of the processing unit.

Optionally, the determiner 1210 may be adapted to determine that a priority-based data being communicated over the one or more second nodes to and from the UE. The transceiving unit 1202 may be adapted to transmit the indication to the one or more second nodes. The indication may indicate to the one or more second nodes to continue the priority-based data communication without causing any interruption.

The transceiving unit 1202 may be adapted to receive the request message from the one or more second nodes. The request message may indicate that one or more internal management operations or external management operations are pending at the one or more second nodes.

The transceiving unit 1202 may be adapted to transmit the response message indicating the one or more second network nodes to perform one or more internal management operations or external management operations.

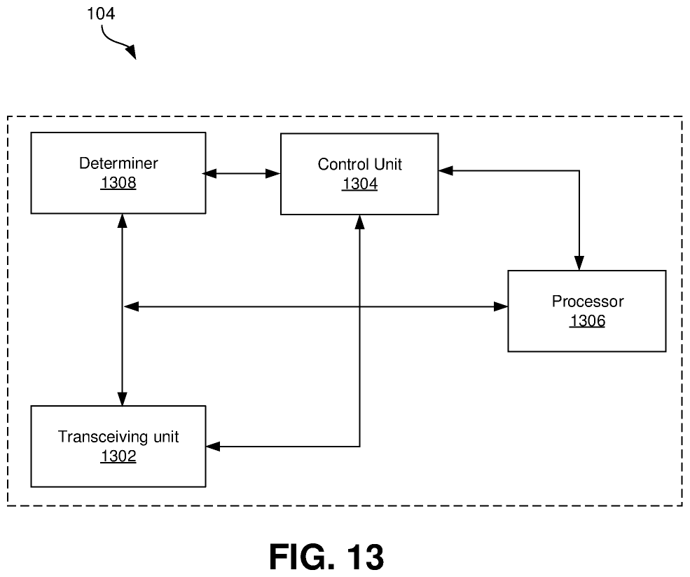

FIG. 13 is an example schematic diagram showing functional modules of the second node 104. The second node in the form of a radio unit, RU, of a RAN or the RU of a network node is capable of operating in one or more modes as described in FIGS. 4 and 5 for interruption free communication of the priority-based data communication.

The RU 104 may comprise means arranged to perform the method 200 for interruption free communication in the wireless communication network.

According to at least some embodiments of the present disclosure, the RU 104 as illustrated in the FIG. 13 may comprise a transceiving unit 1302, a processor 1306, and a determiner 1308. In addition, the radio unit 104 may also comprise a control unit 1304, adapted to control said units.

The transceiving unit 1302 may be adapted to receive the indication from the one or more first nodes, i.e., DUs. The indication may indicate to the second node to continue the priority-based data communication without causing any interruption.

The processor 1306 which may be considered as a data processing unit, may be adapted to generate an indication, for example, to indicate the first nodes about the internal management operations or the external management operations that are pending at the one or more second nodes which one or more internal management operations or external management operations may interrupt the priority-based data communication.

The transceiving unit 1302 may be adapted to receive the request message with the indication for the one or more first nodes to allow the interruption of the priority-based data being communicated over the RU.

Further, the transceiving unit 1302 may be adapted to receive the response message indicating to the RU to perform the internal management operations or the external management operations.

The determiner 1308 and the transceiving unit 1302 may be operatively connected to each other enabling the function of each of the units.

The determiner 1308 may be comprised in one processing unit, which additionally also may comprise the control unit 1304. The function of the determiner 1308 may in this case be performed by determining means of a data processing unit. In some examples, the determiner 1308 may be adapted to determine that the priority-based data being communicated over the second node to and from the UE.

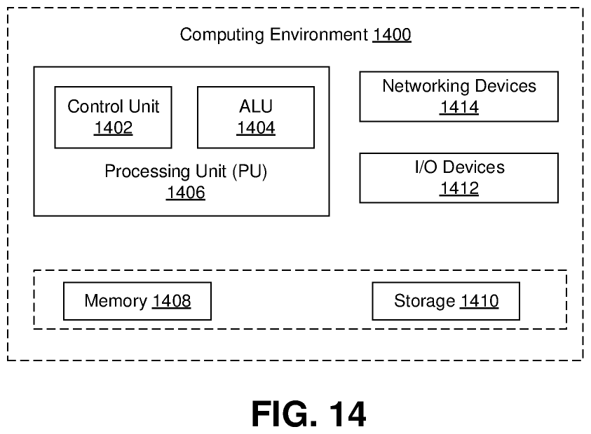

FIG. 14 illustrates an example computing environment 800 implementing a method, the first node and the second node for interruption free communication as described in FIG. 2 and FIG. 3. As depicted in FIG. 14, the computing environment 1400 comprises at least one data processing unit 1406 that is equipped with a control unit 1402 and an Arithmetic Logic Unit, ALU 1404, a memory 1408, a storage 1410, plurality of networking devices 1414 and a plurality Input output, I/O devices 1412. The data processing unit 1406 is responsible for processing the instructions of the algorithm. For example, the data processing unit 1406 is equivalent to the processor of the first node or the second node of the network node. The data processing unit 1406 is capable of executing software instructions stored in memory 1412. The data processing unit 1406 receives commands from the control unit 1402 in order to perform its processing. Further, any logical and arithmetic operations involved in the execution of the instructions are computed with the help of the ALU 1404.

The computer program is loadable into the data processing unit 1406, which may, for example, be comprised in an electronic apparatus (such as a Distributed unit or a radio unit of the network node). When loaded into the data processing unit 1406, the computer program may be stored in the memory 1408 associated with or comprised in the data processor. According to some embodiments, the computer program may, when loaded into and run by the data processing unit 1406, cause execution of method steps according to, for example, any of the methods illustrated in FIGS. 2 and 3 or otherwise described herein

The overall computing environment 1400 may be composed of multiple homogeneous and/or heterogeneous cores, multiple CPUs of different kinds, special media and other accelerators. The data processing unit 1406 is responsible for processing the instructions of the algorithm. Further, the plurality of data processing units 1406 may be located on a single chip or over multiple chips.

The algorithm comprising of instructions and codes required for the implementation are stored in either the memory 1408 or the storage 1410 or both. At the time of execution, the instructions may be fetched from the corresponding memory 1408 and/or storage 1410, and executed by the data processing unit 1406.

In case of any hardware implementations various networking devices 1414 or external I/O devices 1412 may be connected to the computing environment to support the implementation through the networking devices 1414 and the I/O devices 1412.

The embodiments disclosed herein can be implemented through at least one software program running on at least one hardware device and performing network management functions to control the elements. The elements shown in FIG. 14 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the disclosure.

1. A method performed by a second node for an interruption free wireless communication, in a wireless communication network, the method comprising:
detecting that one or more management operations are to be executed at the second node, the execution of the one or more management operations causing an interruption of the wireless communication to from a user equipment; and
upon detecting that the one or more management operations are to be executed at the second node:
receiving an indication from one or more first nodes, the indication indicating to the second node whether or not to execute the one or more management operations; and
determining to execute the one or more management operations based on the received indication.

2. The method according to claim 1, further comprising:
indicating to the one or more first nodes that the one or more management operations are to be executed at the second node.

3. The method according to claim 1, wherein indicating to the one or more first nodes that the one or more management are to be executed at the second node comprises:
transmitting a request message to the one or more first nodes, the request message indicating to the one or more or first nodes to allow the execution of the one or more management operations.

4. The method according to claim 1, further comprising:
awaiting for a pre-configured time interval after transmitting the request message, for receiving the indication from one or more first nodes on whether or not to execute the one or more management operations.

5.-11. (canceled)

12. A method performed by a first node, for an interruption free wireless communication, in a wireless communication network, the method comprising:
determining that priority-based data being communicated over one or more second nodes to and from a user equipment, UE, in the wireless communication network is to be continued without any interruption, for execution of one or more management operations at one or more second nodes;
upon determining that the priority-based data being communicated over one or more second nodes to and from the UE is to be continued without any interruption;
transmitting an indication to the one or more second nodes, the indication indicating to the one or more second nodes whether or not to execute the one or more management operations.

13. The method according to claim 12, further comprising:
receiving an indication from the one or more second nodes that the one or more management operations are to be executed at the one or more second nodes.

14. The method according to claim 12, wherein receiving an indication from the one or more second nodes that the one or more management operations are to be executed at the second node comprises:
receiving a request message from the one or more second nodes, the request message indicating to the first node that one or more management operations are to be executed at the one or more second nodes which one or more management operations interrupt the priority-based data communication.

15. The method according to claim 14, wherein the request message further comprises an indication for the one or more first nodes to allow the interruption of the priority-based data being communicated over the second node.

16. The method according to claim 12, further comprising:
continuously evaluating whether a priority-based data being communicated over one or more second nodes to and from the UE is to be continued without any interruption; and
transmitting an indication to the one or more second nodes, the indication indicating to the one or more second nodes whether or not to execute the one or more management operations.

17.-19. (canceled)

20. A second node in a wireless communication network for providing an interruption free communication, the second node being configured to:
detect that one or more management operations are to be executed at the second node, the execution of the one or more management operations causing an interruption of the wireless communication to from a user equipment; and
upon detecting that the one or more management operations are to be executed at the second node:
receive an indication from one or more first nodes, the indication indicating to the second node whether or not to execute the one or more management operations; and
determine to execute the one or more management operations based on the received indication.

21. The second node according to claim 20, wherein the second node is further configured to:
indicate to the one or more first nodes that the one or more management operations are to be executed at the second node.

22. The second node according to claim 20, wherein the second node indicates to the one or more first nodes that the one or more management are to be executed at the second node by:
transmitting a request message to the one or more first nodes, the request message indicating to the one or more or first nodes to allow the execution of the one or more management operations.

23. The second node according to claim 20, wherein the second node is further configured to:
await for a pre-configured time interval after transmitting the request message, to receive the indication from one or more first nodes as to whether or not to execute the one or more management operations.

24.-30. (canceled)

31. A first node in a wireless communication network for an interruption free wireless communication, the first node being configured to:
determine that a priority-based data being communicated over one or more second nodes to and from a user equipment, UE, in the wireless communication network is to be continued without any interruption, for execution of one or more management operations at one or more second nodes; and
upon determining that the priority-based data being communicated over one or more second nodes to and from the UE is to be continued without any interruption:
transmit an indication to the one or more second nodes, the indication indicating to the one or more second nodes whether or not to execute the one or more management operations.

32. The first node according to claim 31, wherein the first node is further configured to:
receive an indication from the one or more second nodes that the one or more management operations are to be executed at the one or more second nodes.

33. The first node according to claim 31, wherein the first node is configured to receive an indication from the one or more second nodes that the one or more management operations are to be executed at the second node by:
receiving a request message from the one or more second nodes, the request message indicating to the first node that one or more management operations are to be executed at the one or more second nodes which one or more management operations interrupt the priority-based data communication.

34. The first node according to claim 33, wherein the request message further comprises an indication for the one or more first nodes to allow the interruption of the priority-based data being communicated over the second node.

35. The first node according to claim 31, wherein the first node is further configured to:
continuously evaluate whether a priority-based data being communicated over one or more second nodes to and from the UE is to be continued without any interruption; and
transmit an indication to the one or more second nodes, the indication indicating to the one or more second nodes whether or not to execute the one or more management operations.

36.-38. (canceled)

39. A non-transitory computer readable storage medium storing thereon a computer program comprising program instructions that, when run by a data processing unit perform a method, the method comprising:
detecting that one or more management operations are to be executed at a second node, the execution of the one or more management operations causing an interruption of the wireless communication to from a user equipment; and
upon detecting that the one or more management operations are to be executed at the second node:
receiving an indication from one or more first nodes, the indication indicating to the second node whether or not to execute the one or more management operations; and
determining to execute the one or more management operations based on the received indication.
